(19) United States
(12) Patent Application Publication
(10) Pub. No.: US 2022/0038275 A1
(43) Pub. Date: Feb. 3, 2022

(54) DEVICE-SPECIFIC ENCRYPTION KEY GENERATOR AND METHOD

(71) Applicant: SECURITY PLATFORM INC., Gyeonggi-do (KR)

(72) Inventors: Su Ik HWANG, Seoul (KR); Kyung MO KIM, Seoul (KR)

(21) Appl. No.: 17/414,315

(22) PCT Filed: Nov. 8, 2019
(86) PCT No.: PCT/KR2019/015129

§ 371 Date: Jun. 15, 2021

(30) Foreign Application Priority Data
Dec. 18, 2018 (KR) 10-2018-0164134

(51) Int. Cl. H04L 9/08; H04L 9/06

(52) U.S. Cl. CPC H04L 9/0866; H04L 9/0643; H04L 9/0869

(57) ABSTRACT

In a method of creating a device unique encryption key, a processor transmits, to an execution-only memory device, a request for creating a unique encryption key for a specific device and an identifier of the specific device; the execution-only memory device executes an execution-only routine stored therein to create a unique encryption key; and the execution-only memory device outputs the created unique encryption key to the processor as the unique encryption key of the specific device, wherein a controller of the execution-only memory device obtains a unique key stored in an internal memory without external access, and processes a key calculation algorithm based on the identifier of the specific device received from the processor and the unique key to create the unique encryption key.

### TECHNICAL FIELD

The present disclosure relates to an electronic device, and more particularly, to a creator for creating a unique encryption key to be used exclusively for a single device and to a method for creating the same.

### DISCUSSION OF RELATED ART

The internet of things (IoT) is a system providing connection through the internet by mounting sensors and processors on the things (e.g., devices) to collect information and control and manage the devices. The devices that constitute the IoT may include various forms and characteristics, for example, from devices having a very simple sensing function and performing a serial communication at the serial peripheral interface (SPI) level to devices having various sensing functions and high-performance computing capabilities such as smartphones.

In such IoT, it is a very important technical issue to prevent malfunctions or unintended functions from being executed by devices that perform malicious roles. Device authentication and identification are indispensable for enhancing device security in the IoT. As technologies used for authentication and identification of IoT devices, various methods are used, for example, using a certificate, using an ID/password, using a token with authority, using an identification device such as a subscriber identity module (SIM), and using a unique identifier.

In order to satisfy basic security requirements such as confidentiality and integrity of data on various devices of the IoT, it is necessary to provide encryption algorithms that may perform encryption/decryption and create hash values and message integrity code (MIC) values. To this end, various encryption algorithms have been applied, and a method of encrypting messages transmitted and received to or from IoT devices by using encryption keys using such encryption algorithms have been used.

Meanwhile, in recent years, for more enhanced security, various technologies for creating encryption keys that are unclonable by using unique characteristics of hardware have been proposed. Among them, physical unclonable function (PUF) is a technology that creates a physically unique code for authentication and security, and conventionally, techniques for creating each unique key by using a ring oscillator, a latch, and the like have been proposed.

In this regard, Korean Patent Registration No. 1408619 titled “Physical unclonable function system based on capacitance variations” discloses the configuration including two or more physical unclonable function (PUF) cells and a control signal generator for generating a control signal to control the operation of each PUF cell. Specifically, the configuration in which each PUF cell operates according to the control signal, and includes a charge sharing circuit including a circuit in which two or more capacitors are arranged in parallel, a comparator for detecting a difference in capacity of some capacitors among capacitors in the charge sharing circuit, and a logical exclusive-OR gate for executing a logical exclusive-OR operation for an input signal (Challenge) and the signal output from the comparator and outputting an output signal (Response) as the result has been disclosed.

In the case of a PUF designed using such hardware, dedicated hardware is essential, and since the dedicated hardware is configured outside the CPU in most devices, there have been limitations in its utilization and costs. In order to overcome the shortcomings of hardware PUFs, a technology for implementing PUF in terms of software has also been developed. However, not only is there a high possibility of cost problems even in the case of software PUFs, but there also is a problem that both types of PUFs may not guarantee stability according to environmental changes such as temperature, humidity, current, and voltage.

In order to overcome the limitations of PUF, a security key provision technology using hardware-specific information has been developed. For example, in the case of a microcontroller unit (MCU) of a semiconductor, a security key may be created by using a lot number, which is the unique information of the semiconductor, and coordinates of a wafer (i.e., arbitrary position coordinates based on x and y axes), and then it may be recorded as a unique security key on a semiconductor chip.

Conventionally, however, since it is possible to read the hardware unique key from an arbitrary firmware, there has been a problem that the encryption key may be easily calculated from the outside when the rules (or formulas) for creating the encryption key are exposed.

### DETAILED DESCRIPTION OF THE INVENTION

### Technical Objectives

Aspects of embodiments of the present disclosure are directed to a device unique encryption key creator and a method of creating the same, in which a device-specific unique encryption key is created by using a unique identifier of the device, where the device-specific unique encryption key is created through the use of a unique key stored in a trusted execution environment (TEE) that cannot be accessed from the outside and an execution-only routine, thereby capable of creating and providing a unique encryption key that may be used exclusively for a single device.

The technical objectives to be achieved by embodiments of the present disclosure are not limited to the technical objectives as described above, and other technical objectives may be inferred from the following embodiments.

### Technical Solution to the Problem

According to an embodiment, a device unique encryption key creator includes: an execution-only memory device including a memory in which a firmware for executing an execution-only routine and a unique key are stored so that external access is impossible, and a controller configured to execute the execution-only routine to process creation of a unique encryption key for an arbitrary device; and a processor configured to transmit, to the execution-only memory device, a request for creating a unique encryption key for a specific device and a unique identifier of the specific device. In such an embodiment, when the request for creating the unique encryption key for the specific device and the identifier of the specific device are received, in accordance with execution of the execution-only routine, the controller of the execution-only memory device processes a key calculation algorithm based on the identifier of the specific device and the unique key stored in the memory and outputs, as the unique encryption key of the specific device, a unique encryption key created as a result of processing the key calculation algorithm.

In some embodiments, in accordance with execution of the execution-only routine, the controller of the execution-only memory device may discard the unique encryption key after outputting the unique encryption key, and newly create the unique encryption key each time the request for creating the unique encryption key for the specific device is received from the processor.

In some embodiments, in accordance with execution of the execution-only routine, the controller of the execution-only memory device may process a key calculation by using the identifier of the specific device and the unique key as inputs of a symmetric key algorithm.

In some embodiments, in accordance with execution of the execution-only routine, the controller of the execution-only memory device may process a key calculation by using the identifier of the specific device and the unique key as inputs of a hash function algorithm.

In some embodiments, the identifier of the specific device may be a serial number uniquely assigned to a corresponding product model, and the unique key stored in the memory of the execution-only memory device may include at least one of random number and letter.

According to another embodiment, a method of creating a device unique encryption key performed by a device unique encryption key creator includes: transmitting, by a processor, a request for creating a unique encryption key for a specific device and a unique identifier of the specific device to an execution-only memory device; creating a unique encryption key by executing, by the execution-only memory device, an execution-only routine stored therein; and outputting, by the execution-only memory device, the created unique encryption key to the processor as the unique encryption key of the specific device. In such an embodiment, creating of the unique encryption key by the execution-only memory device includes obtaining, by a controller of the execution-only memory device, a unique key stored in an internal memory so that external access is impossible; and creating a unique encryption key by processing, by the controller, a key calculation algorithm based on the identifier of the specific device received from the processor and the stored unique key.

In some embodiments, the method may further include: after outputting the created unique encryption key to the processor, discarding, by the execution-only memory device, the created unique encryption key in accordance with execution of the execution-only routine, wherein the execution-only routine may be set such that the unique encryption key is newly created each time the request for creating the unique encryption key is received from the processor.

In some embodiments, creating of the unique encryption key by processing the key calculation algorithm may include: processing a key calculation by using the identifier of the specific device and the unique key as inputs of a symmetric key algorithm

In some embodiments, creating of the unique encryption key by processing the key calculation algorithm may include: processing a key calculation by using the identifier of the specific device and the unique key as inputs of a hash algorithm

In some embodiments, the identifier of the specific device may be a serial number uniquely assigned to a corresponding product model, and the unique key stored in the memory of the execution-only memory device may include at least one of random number and letter.

According to another embodiment, a recording medium is recorded with a device unique encryption key creation program, the device unique encryption key creation program configured to execute: executing an execution-only routine when a request for creating a unique encryption key for a specific device is received; loading a unique identifier of the specific device from a predetermined path; reading a unique key stored in an internal area so that external access is impossible; creating a unique encryption key by processing a key calculation algorithm based on the identifier of the specific device and the unique key; and outputting the unique encryption key created as a processing result of the key calculation algorithm.

### Effects of the Invention

According to one or more embodiments of the present disclosure, device security may be greatly improved by creating an unclonable encryption key by using a device's unique identifier and a unique key which is stored so that it cannot be obtained from the outside.

In other words, by creating the device's unique encryption key based on information that may be checked only on an execution-only memory device and a firmware that may be executed only on the execution-only memory device, the device unique encryption key, along with a unique encryption key calculation process, is not exposed to the outside.

Further, according to one or more embodiments of the present disclosure, the device unique encryption key created in the execution-only memory device is discarded immediately after output and is not stored on the device or the execution-only memory device, so that exposure to the outside may be blocked.

In addition, according to one or more embodiments of the present disclosure, by using the device identifier and the execution-only memory which are technologies that have been conventionally applied to a CPU and the like, additional parts and information for implementing the device unique encryption key creator are not required, thereby allowing wide application on various hardware at low cost.

### BRIEF DESCRIPTION OF THE DRAWINGS

FIG. 1 is a block diagram illustrating a configuration of a device unique encryption key creator according to an embodiment of the present disclosure.

FIG. 2 is a block diagram illustrating a configuration of a device unique encryption key creator according to another embodiment of the present disclosure.

FIG. 3 is a block diagram illustrating a configuration of an execution-only memory device according to an embodiment of the present disclosure.

FIG. 4 is a conceptual diagram illustrating a process of creating a device unique encryption key in an execution-only memory device according to an embodiment of the present disclosure.

FIG. 5 is a flowchart illustrating a device unique encryption key creation routine executed in an execution-only memory device according to an embodiment of the present disclosure.

FIG. 6 is a flowchart illustrating a method of creating a device unique encryption key according to an embodiment of the present disclosure.

### DETAILED DESCRIPTION

Hereinafter, some embodiments will be described clearly and in detail with reference to the accompanying drawings so that those with ordinary skill in the technical field to which the present disclosure pertains (hereinafter, those with ordinary skill) may easily implement inventive concept of the present disclosure.

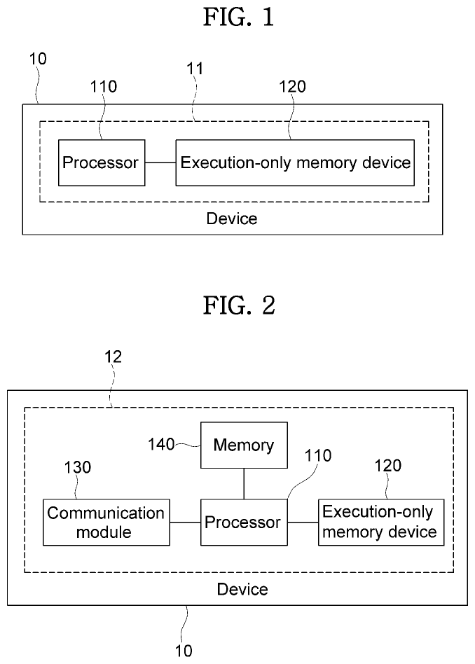

FIG. 1 is a block diagram illustrating a configuration of a device unique encryption key creator according to an embodiment of the present disclosure.

Although FIG. 1 illustrates that a device unique encryption key creator (e.g., device-specific encryption key generator) 11 is included as part of a specific device 10, the device unique encryption key creator 11 according to an embodiment of the present disclosure may be implemented separately outside the device 10 or may be removably mounted to the device 10 to be electrically connected and interwork with the device 10.

The device 10 according to an embodiment of the present disclosure may refer to an electronic apparatus itself that independently processes a predetermined specific operation or function or may be included as part of an electronic apparatus to operate independently or interwork with other devices in the apparatus, and its operation and function are not limited.

For example, the device 10 may be a smartphone, a tablet personal computer (PC), a mobile phone, a video phone, a desktop PC, a laptop PC, a netbook computer, a smart watch, or the like. In addition, the device 10 may be a smart home appliance, for example, a TV, a digital video disk (DVD) player, an audio, a refrigerator, an air conditioner, a vacuum cleaner, an oven, a microwave oven, a washing machine, an air cleaner, a set-top box, a home automation control panel, a security control panel, a game console, and the like. In addition, the device 10 may be an internet of things (IoT) device, for example, various sensors, electricity or gas meters, sprinkler devices, fire alarms, thermostats, exercise equipment, hot water tanks, heaters, boilers, navigation devices, global positioning system (GPS) receivers, event data recorder (EDR), flight data recorder (FDR), vehicle infotainment devices, and the like. In various embodiments, the device 10 may be a combination of one or more of the various devices described above. However, the device 10 is not limited to the above-described devices and may include a new electronic device according to technological advances.

Referring back to FIG. 1, the device unique encryption key creator 11 according to an embodiment of the present disclosure includes a processor 110 and an execute-only memory (XOM) device 120.

The execution-only memory (XOM) device is a memory device that allows only instruction fetches and does not allow access for read and write. When such an execution-only memory device is used, it is possible to prevent an arbitrary user from accessing codes on the execution-only memory device for reading or writing. For example, firmware may be disposed in the execution-only memory device and user codes and drivers may be separately loaded, such that it is possible to prevent other users (e.g., external firmware) from reading the code.

The processor 110 controls an overall operation for providing a unique encryption key that is to be used exclusively for (e.g., specific to) the device 10 (hereinafter, “unique encryption key”). To this end, the processor 110 may be implemented by including at least one processing unit (e.g., CPU, micro-processor, DSP, etc.), random access memory (RAM), read-only memory (ROM), and the like.

In general, an encryption key refers to a critical information value necessary for an encryption algorithm that encrypts or decrypts plain text and is used to encrypt or decrypt an arbitrary message. In an embodiment of the present disclosure, the unique encryption key of the device 10 may be used to encrypt messages transmitted and received between the device 10 and a server (not illustrated) when the device 10 is defined as a client. For example, if the client (i.e., the device 10) is a power meter and the server is a power provider's server, the power provider's server may calculate and charge for supplied power based on data received from the power meter located in each home. In such a case, a message is encrypted by using its own unique encryption key for each power meter, when transmitting and receiving the data with the power provider's server, thereby ensuring confidentiality and integrity of the corresponding data.

Specifically, in response to a request for creating a unique encryption key for the device 10 requested from the outside or occurring in the device 10 itself, the processor 110 transmits the request for creating a unique encryption key to the execution-only memory device 120. In such an embodiment, the processor 110 provides a unique identifier of the device 10 (hereinafter, “device identifier (Unique ID)”) to the execution-only memory device 120.

The device identifier is uniquely assigned to identify the device 10 from other devices, and may be, for example, a serial number uniquely assigned to the product model by the manufacturer when the device 10 is manufactured.

Further, the processor 110 receives the unique encryption key created from the execution-only memory device 120 and uses it as the encryption key of the device 10. That is, the processor 110 provides a unique encryption key to a corresponding destination in response to a request for a unique encryption key that is requested from the outside or occurs internally of the device 10.

The general functions of a memory may mean read, write, and execute operations. On the other hand, the device unique encryption key creator 11 according to an embodiment of the present disclosure uses the execution-only memory device 120 which rejects read and write operations and only allows specific execution operations to create and provide the device unique encryption key (e.g., device-specific encryption key).

The execution-only memory device 120 creates and outputs a unique encryption key for a specific device by performing an execution-only routine upon request from an external device (e.g., processor 110). In such an embodiment, operations such as data processing and operations executed in the execution-only memory device 120 may not be read or written externally, and only an output result may be checked.

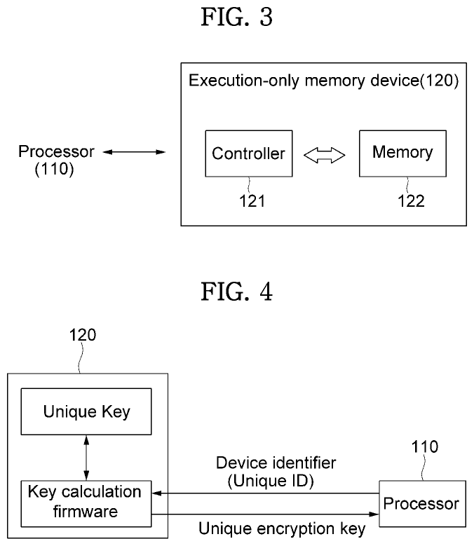

Features and operations of the execution-only memory device 120 will be described in detail with reference to FIGS. 3 to 5 below.

In an embodiment, the device unique encryption key creator 11 may further include a detailed configuration for performing processing such as data transmission/reception between internal components of the device 10 or with external devices (not illustrated).

FIG. 2 is a block diagram illustrating a configuration of a device unique encryption key creator according to another embodiment of the present disclosure.

In such an embodiment, a device unique encryption key creator 12 according to another embodiment of the present disclosure includes all the configurations of the device unique encryption key creator 11 described with respect to FIG. 1 above, but further includes a communication module 130 and a memory 140.

The communication module 130 transmits, to the processor 110, a device unique encryption key request which has occurred inside the device 10 or a device unique encryption key request received from the outside of the device 10.

In addition, the communication module 130 transmits a unique encryption key of the device 10 to the corresponding requester as a response to the device unique encryption key request under the control of the processor 110.

A device unique encryption key creation program is stored in the memory 140, and this program is driven by the processor 110. In addition, at least one program for controlling the overall operation of the device unique encryption key creator 12 may be further stored in the memory 140.

In addition, a unique identifier (i.e., device identifier) of the device 10 is stored in the memory 140.

The memory 140 may collectively refer to a non-volatile storage device that continuously maintains stored information even when power is not supplied, and a volatile storage device that requires power to maintain stored information.

In addition, the memory 140 may serve to temporarily or permanently store data processed by the processor 110. In such an embodiment, the memory 140 may include a magnetic storage medium or a flash storage medium in addition to the volatile storage device requiring power to maintain stored information, but embodiments are not limited thereto.

In such an embodiment, the processor 110 may execute the device unique encryption key creation program stored in the memory 140 to control the overall operation for providing the unique encryption key of the device 10. For example, the processor 110 may read the program stored in the memory 140 into RAM and execute it through at least one processing unit.

Specifically, when receiving a device unique encryption key request from the outside through the communication module 130 or a device unique encryption key request generated in the device 10 itself, the processor 110 requests the execution-only memory device 120 for a unique encryption key in accordance with execution of the device unique encryption key creation program. In such an embodiment, the processor 110 may obtain the device identifier of the device 10 from the memory 140 and provide it to the execution-only memory device 120.

Then, the processor 110 receives the unique encryption key of the device 10 from the execution-only memory device 120 in response to the device unique encryption key creation request and provides the received unique encryption key to the corresponding requester. That is, in response to the device unique encryption key request from the inside or outside of the device 10 received through the communication module 130, the processor 110 provides the unique encryption key of the device 10 to the corresponding requester, a destination, through the communication module 130.

Hereinafter, an operation performed by the execution-only memory device 120 upon receiving the request for creating the device unique encryption key from the processor 110 will be described in detail with reference to FIGS. 3 to 5.

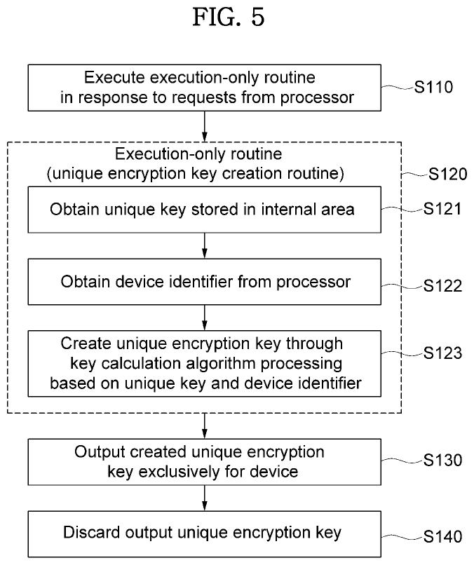

FIG. 3 is a block diagram illustrating a configuration of an execution-only memory device according to an embodiment of the present disclosure, and FIG. 4 is a conceptual diagram illustrating a process of creating a device unique encryption key in an execution-only memory device according to an embodiment of the present disclosure. In addition, FIG. 5 is a flowchart illustrating a routine for creating a device unique encryption key executed in an execution-only memory device according to an embodiment of the present disclosure.

As illustrated in FIG. 3, the execution-only memory device 120 includes a memory 122 and a controller 121 for controlling an operation of the memory 122.

The controller 121 may control input/output of data to or from the memory 122. The controller 121 and the memory 122 may be connected to each other through a bus channel, and control signals and data signals may be transmitted between the controller 121 and the memory 122 through the bus channel.

The controller 121 may include one or more hardware components (e.g., analog circuits, logic circuits, and the like) configured to perform functions to be described below. Additionally, or alternatively, the controller 121 may include one or more processor cores. The functions of the controller 121 to be described below may be implemented as program code of software and/or firmware, and the processor core(s) of the controller 121 may execute an instruction set of the program code. The processor core(s) of the controller 121 may process various types of arithmetic operations and/or logical operations to execute the instruction set.

The controller 121 executes a device unique encryption key creation routine in response to the device unique encryption key creation request received from the outside (e.g., the processor 110). The device unique encryption key creation routine is an execution-only routine, and the controller 121 restricts external access such as read or write for the execution-only routine and only allows output of the execution result to the outside.

The memory 122 may include a volatile memory and/or a non-volatile memory.

In such an embodiment, a unique key and a firmware for executing the execution-only routine are stored in one area of the execution-only memory device 120 (i.e., one area of the memory 122). The unique key may be data including at least one of random (e.g., arbitrary) number and letter. The firmware and the unique key stored in the execution-only memory device 120 may be stored by the manufacturer of the memory device during or immediately after the manufacturing process of the execution-only memory device 120.

Referring to FIG. 4, in the execution-only memory device 120, a unique key that is uniquely assigned to the execution-only memory device 120 and a firmware that performs the device unique encryption key creation routine (e.g., “key calculation firmware”) are stored so that external access is impossible.

In such an embodiment, the unique key stored in the execution-only memory device 120 is read only in the execution-only memory device 120 by the key calculation firmware, and processes (i.e., read, write, erase, etc.) in response to the external connection or request are all rejected.

In addition, the firmware stored in the execution-only memory device 120 includes an execution-only routine for executing a predetermined key calculation algorithm. In accordance with execution of the key calculation algorithm, creation of the unique encryption key using the unique key stored in the execution-only memory device 120 is processed.

Accordingly, even if it is assumed that the same key calculation algorithm is used for each of a plurality of devices, respectively different unique encryption keys are created for each device because the unique keys stored in each execution-only memory device 120 are different for each device. In addition, since the key calculation algorithm (i.e., the key calculation process) operates only on the execution-only memory device 120, it is not exposed to the outside.

With reference to FIG. 5, a description of a process will be given in which the controller 121 of the execution-only memory device 120 receives the unique encryption key creation request from the processor 110 and then processes creation of the device unique encryption key.

The controller 121 executes an execution-only routine in response to a request for creating a device unique encryption key for the device 10 from the processor 110 (S110).

In accordance with execution of the execution-only routine, the controller 121 creates the unique encryption key of the device 10 based on a unique key stored in the memory 122 and a device identifier of the device 10 obtained from the processor 110. (S120).

Specifically, the controller 121 obtains the unique key stored in an area (i.e., memory 122) of the execution-only memory device 120 (S121) and obtains the identifier of the device 10 from the processor 110 (S122). In such a case, the order of the controller 121 obtaining the unique key (S121) and obtaining the device identifier (S122) is not limited and they may be processed in parallel. For example, when the processor 110 transmits the device identifier of the specific device 10, along with the request for creating the unique encryption key for the specific device 10, to the execution-only memory device 120, the controller 121 may firstly perform obtaining of the device identifier of the specific device 10, while simultaneously executing the execution-only routine.

Then, the controller 121 creates the unique encryption key by performing a predetermined key calculation algorithm based on the obtained unique key and device identifier (S123).

In such a case, the controller 121 may use a symmetric-key algorithm as the key calculation algorithm and may process the key calculation by using the unique key and the device identifier as inputs of the symmetric key algorithm. For example, an advanced encryption standard algorithm (AES algorithm) may be applied as the symmetric key encryption algorithm.

In addition, the controller 121 may use a hash function algorithm as the key calculation algorithm and may process the key calculation by using the unique key and the device identifier as inputs of the hash function algorithm. For example, a secure hash algorithm (SHA algorithm) may be applied as the hash function algorithm.

As such, the key calculation algorithm may have characteristics of a function, and an input value and an output value may have a 1:1 correlation.

Next, according to the execution-only routine, the controller 121 outputs the created unique encryption key to the processor 110 as the unique encryption key of the device 10 (S130).

In addition, after outputting the created unique encryption key to the processor 110, the controller 121 of the execution-only memory device 120 according to an embodiment of the present disclosure may immediately discard the corresponding unique encryption key (S140).

That is, the execution-only memory device 120 does not separately store the created unique encryption key and performs the unique encryption key creation process each time the processor 110 requests for the unique encryption key, thereby more effectively preventing the corresponding unique encryption key from being exposed to the outside.

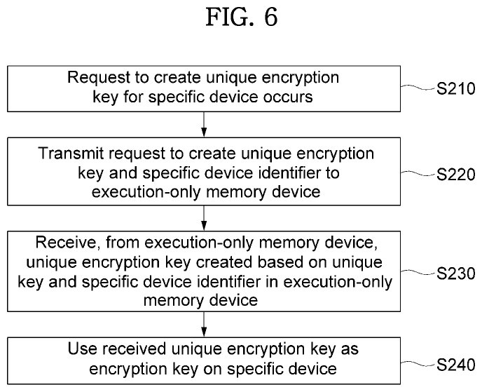

Hereinafter, a method of creating a device unique encryption key according to an embodiment of the present disclosure will be described with reference to FIG. 6. In such a case, the method of creating the device unique encryption key illustrated in FIG. 6 may be processed by the processor 110 described above.

FIG. 6 is a flowchart illustrating a method of creating a device unique encryption key according to an embodiment of the present disclosure.

When a request for creating a unique encryption key for a specific device (i.e., device 10) occurs (S210), the request for creating the device unique encryption key for the specific device is transmitted to the execution-only memory device 120 (S220).

In such an embodiment, the request for creating the device unique encryption key may be generated in the device itself or may be received from another external device.

In addition, a unique identifier (i.e., device identifier) of the specific device, along with the request for creating the device unique encryption key, may be provided to the execution-only memory device 120. In addition, it is also possible to provide the device identifier at the request of the execution-only memory device 120 or sequentially after the device unique encryption key creation request.

Then, the unique encryption key for the device 10 created according to execution of the execution-only routine in the execution-only memory device 120 is received from the execution-only memory device 120 (S230).

Specifically, when the device unique encryption key creation request is received, the execution-only memory device 120 executes an execution-only routine to read a unique key stored internally so that external access is impossible and to load the device identifier from a predetermined path (e.g., obtaining data provided by the processor 110), and creates the unique encryption key by using the unique key and the device identifier as inputs of a predetermined key calculation algorithm. In such a case, the key calculation algorithm may be set as a function to process arbitrary calculations, such as a symmetric key algorithm or a hash function algorithm. Further, the execution-only memory device 120 outputs the unique encryption key created as a result of processing the calculation algorithm according to the execution-only routine.

Next, the received unique encryption key is used as the encryption key of the specific device (S240).

In such an embodiment, in response to the device unique encryption key creation request which occurred in step S210, the unique encryption key is provided to the corresponding requester.

In addition, since the unique encryption key is discarded immediately after being output from the execution-only memory device 120, the above steps S210 to S240 are repeatedly processed whenever a security key creation request occurs.

The method for creating a device unique encryption key according to an embodiment of the present disclosure described above may be implemented in the form of a recording medium including instructions executable by a computer, such as a program module executed by a computer. Computer-readable media may be any available media that may be accessed by a computer and include all of volatile and non-volatile media and removable and non-removable media. In addition, the computer-readable media may include computer storage media, and the computer storage media may include all of volatile and non-volatile media and removable and non-removable media implemented in any method or technology for storage of information such as computer-readable instructions, data structures, program modules, or other data.

Although the methods and systems of the present disclosure have been described in connection with specific embodiments, some or all of their components or operations may be implemented using a computer system having a general-purpose hardware architecture.

The above description of the present disclosure is for illustrative purposes only, and those of ordinary skill in the art will understand that modifications may be easily made into other specific forms without changing the technical spirit or essential features of the present disclosure. Accordingly, it is to be understood that the embodiments described above are illustrative and non-limiting in all respects. For example, each component described as a single type may be implemented in a distributed manner, and similarly, components described as being distributed may also be implemented in a combined form.

The scope of the present disclosure may be indicated by the claims to be described below rather than the detailed description, and all changes or modified forms derived from the meaning and scope of the claims and their equivalent concepts should be interpreted as being included within the scope of the present disclosure.

1. A device unique encryption key creator comprising:
an execution-only memory device comprising a memory in which a firmware for executing an execution-only routine and a unique key are stored so that external access is impossible, and a controller configured to execute the execution-only routine to process creation of a unique encryption key for an arbitrary device; and
a processor configured to transmit, to the execution-only memory device, a request for creating a unique encryption key for a specific device and a unique identifier of the specific device,
wherein when the request for creating the unique encryption key for the specific device and the identifier of the specific device are received, in accordance with execution of the execution-only routine, the controller of the execution-only memory device processes a key calculation algorithm based on the identifier of the specific device and the unique key stored in the memory and outputs, as the unique encryption key of the specific device, a unique encryption key created as a result of processing the key calculation algorithm.

2. The device unique encryption key creator of claim 1, wherein in accordance with execution of the execution-only routine, the controller of the execution-only memory device discards the unique encryption key after outputting the unique encryption key, and
newly creates the unique encryption key each time the request for creating the unique encryption key for the specific device is received from the processor.

3. The device unique encryption key creator of claim 1, wherein in accordance with execution of the execution-only routine, the controller of the execution-only memory device processes a key calculation by using the identifier of the specific device and the unique key as inputs of a symmetric key algorithm.

4. The device unique encryption key creator of claim 1, wherein in accordance with execution of the execution-only routine, the controller of the execution-only memory device processes a key calculation by using the identifier of the specific device and the unique key as inputs of a hash function algorithm.

5. The device unique encryption key creator of claim 1, wherein the identifier of the specific device is a serial number uniquely assigned to a corresponding product model, and
the unique key stored in the memory of the execution-only memory device includes at least one of random number and letter.

6. A method of creating a device unique encryption key performed by a device unique encryption key creator, the method comprising:
transmitting, by a processor, a request for creating a unique encryption key for a specific device and a unique identifier of the specific device to an execution-only memory device;
creating a unique encryption key by executing, by the execution-only memory device, an execution-only routine stored therein; and
outputting, by the execution-only memory device, the created unique encryption key to the processor as the unique encryption key of the specific device,
wherein creating of the unique encryption key by the execution-only memory device comprises:
obtaining, by a controller of the execution-only memory device, a unique key stored in an internal memory so that external access is impossible; and
creating a unique encryption key by processing, by the controller, a key calculation algorithm based on the identifier of the specific device received from the processor and the stored unique key.

7. The method of claim 6, further comprising: after outputting the created unique encryption key to the processor,
discarding, by the execution-only memory device, the created unique encryption key in accordance with execution of the execution-only routine,
wherein the execution-only routine is set such that the unique encryption key is newly created each time the request for creating the unique encryption key is received from the processor.

8. The method of claim 6, wherein creating of the unique encryption key by processing the key calculation algorithm comprises:
processing a key calculation by using the identifier of the specific device and the unique key as inputs of a symmetric key algorithm

9. The method of claim 6, wherein creating of the unique encryption key by processing the key calculation algorithm comprises:
processing a key calculation by using the identifier of the specific device and the unique key as inputs of a hash algorithm

10. The method of claim 6, wherein the identifier of the specific device is a serial number uniquely assigned to a corresponding product model, and
the unique key stored in the memory of the execution-only memory device includes at least one of random number and letter.

11. A recording medium on which a device unique encryption key creation program is recorded, the device unique encryption key creation program configured to execute:
executing an execution-only routine when a request for creating a unique encryption key for a specific device is received;
loading a unique identifier of the specific device from a predetermined path;
reading a unique key stored in an internal area so that external access is impossible;
creating a unique encryption key by processing a key calculation algorithm based on the identifier of the specific device and the unique key; and
outputting the unique encryption key created as a processing result of the key calculation algorithm.
